(19) United States
(12) Patent Application Publication
(10) Pub. No.: US 2025/0208722 A1
(43) Pub. Date: Jun. 26, 2025

(54) ULTRASONIC MODULE AND ULTRASONIC MOUSE USING SAME

(71) Applicant: SonicMEMS (ZhengZhou) Technology Co.,Ltd., Zhengzhou (CN)

(72) Inventors: Yi-Hsiang Chiu, Zhengzhou (CN); Rei Jinchi, Zhengzhou (CN); Hsien-Tsong Chen, Zhengzhou (CN)

(21) Appl. No.: 18/739,739

(22) Filed: Jun. 11, 2024

(30) Foreign Application Priority Data
Dec. 26, 2023 (TW) 112150879

(51) Int. Cl. G06F 3/0354

(52) U.S. Cl. CPC G06F 3/03543

(57) ABSTRACT

An ultrasonic module is provided, including a substrate, an ultrasonic transmitting element, and an ultrasonic receiving element. The substrate includes a slot. The slot includes a first side and a second side. An acute angle is formed between the first side and the second side. The ultrasonic transmitting element is on the first side and configured to generate an ultrasonic wave signal. The ultrasonic receiving element is on the second side and configured to receive a reflected wave of the ultrasonic wave signal. The ultrasonic module may be applied to a mouse, and may be configured to calculate a moving path of the ultrasonic mouse by sensing reflection of ultrasonic waves. In this way, a sensing problem of a traditional optical mouse can be resolved without being affected by a material on which the mouse is placed.

### CROSS-REFERENCE TO RELATED APPLICATION

This non-provisional application claims priority under 35 U.S.C. § 119 (a) to patent application Ser. No. 11/215,0879 filed in Taiwan, R.O.C. on Dec. 26, 2023, the entire contents of which are hereby incorporated by reference.

### BACKGROUND

### Technical Field

The present invention relates to the field of sensing, and in particular, to an ultrasonic module and an ultrasonic mouse using the same.

### Related Art

A mouse is currently a common input device for uploading in a computer application. A mainstream mouse at the current stage is an optical mouse, and the operation principle is to collect a movement orientation of the mouse on a surface of an object through an LED light source with a photoelectric sensor or a small lens. Relative movements of the mouse on various surfaces are calculated based on the collected result through a small image processing chip, and a movement signal is transmitted to a computer to generate a movement of a cursor on a screen.

However, optical mouses are insensitive on light-transmissive materials such as glass or on smooth surfaces as a result of transmission or scattering of light. Although improvements have been made at present by using laser light sources or the like, they have an overall cost much higher than traditional LED light sources.

### SUMMARY

With the recent maturity of ultrasonic sensor technologies, a sensing distance may be greatly shortened, and costs are also greatly reduced. This application is intended to replace conventional optical sensing with an ultrasonic wave, and the ultrasonic wave may be applied to various interfaces.

To resolve the problems faced in the prior art, an ultrasonic module is provided herein. In some embodiments, the ultrasonic module includes a substrate, an ultrasonic transmitting element, and an ultrasonic receiving element. The substrate includes a slot, the slot includes a first side and a second side, and an acute angle is formed between the first side and the second side. The ultrasonic transmitting element is on the first side and configured to generate an ultrasonic wave signal. The ultrasonic receiving element is on the second side and configured to receive a reflected wave of the ultrasonic wave signal.

In some embodiments, the ultrasonic module further includes a baffle. The baffle is in the slot and between the ultrasonic transmitting element and the ultrasonic receiving element.

In some embodiments, the substrate is a semiconductor substrate or a ceramic substrate.

In some embodiments, the ultrasonic transmitting element includes one or more ultrasonic transmitters.

In some embodiments, the ultrasonic receiving element includes one or more ultrasonic receivers.

Herein, an ultrasonic mouse is further provided. In some embodiments, the ultrasonic mouse includes an ultrasonic module, a housing, and a microprocessor. The ultrasonic module includes a substrate, an ultrasonic transmitting element, and an ultrasonic receiving element. The substrate includes a slot, the slot includes a first side and a second side, and an acute angle is formed between the first side and the second side. The ultrasonic transmitting element is on the first side and configured to generate an ultrasonic wave signal. The ultrasonic receiving element is on the second side and configured to receive a reflected wave of the ultrasonic wave signal. The housing includes an opening, from which the ultrasonic transmitting element and the ultrasonic receiving element are exposed. The microprocessor is in the housing and electrically connected to the ultrasonic transmitting element and the ultrasonic receiving element. When the ultrasonic mouse moves, the ultrasonic receiving element generates a receiving signal based on a reflection angle of the ultrasonic wave signal, and the microprocessor generates and transmits a displacement signal based on a change of the receiving signal.

In some embodiments, the ultrasonic module further includes a baffle. The baffle is in the slot and between the ultrasonic transmitting element and the ultrasonic receiving element.

In some embodiments, the substrate is a semiconductor substrate or a ceramic substrate.

In some embodiments, the ultrasonic transmitting element includes one or more ultrasonic transmitters.

In some embodiments, the ultrasonic receiving element includes one or more ultrasonic receivers.

As shown in the foregoing embodiments, the ultrasonic module may be applied to an ultrasonic mouse, and may be configured to calculate a moving path of the ultrasonic mouse by sensing reflection of ultrasonic waves. In this way, a sensing problem of a traditional optical mouse may be resolved without being affected by a material on which the mouse is placed.

### BRIEF DESCRIPTION OF THE DRAWINGS

FIG. 1 is an exploded view of an embodiment of an ultrasonic mouse.

FIG. 2 is a block diagram of an embodiment of an ultrasonic mouse.

FIG. 3 is a three-dimensional view of a first embodiment of an ultrasonic module.

FIG. 4 is a three-dimensional view of a second embodiment of an ultrasonic module.

FIG. 5 is a three-dimensional view of a third embodiment of an ultrasonic module.

FIG. 6 is a three-dimensional view of a fourth embodiment of an ultrasonic module.

### DETAILED DESCRIPTION

It should be understood that when an element is referred to as being “arranged” on another element, it may indicate that the element is directly located on another element, or an intermediate element exists, and the element is connected to another element through the intermediate element. On the contrary, when an element is referred to as being “directly arranged on another element” or “directly mounted to another element”, it may be understood that it is explicitly defined that no intermediate element exists in this case.

In addition, terms “first”, “second”, and “third” are only used to distinguish one element, component, region, layer, or section from another element, component, region, layer, or section, rather than indicating an inevitable sequence therebetween. In addition, relative terms such as “under” and “upper” may be used herein to describe a relationship between one element and another element. It should be understood that relative terms are intended to include differences in devices other than the devices at the orientation shown in the figure. For example, if a device in an accompanying drawing is flipped, an element described as being on a “lower” side of another element is to be oriented on an “upper” side of the another element. This only represents a relative orientation relationship, not an absolute orientation relationship.

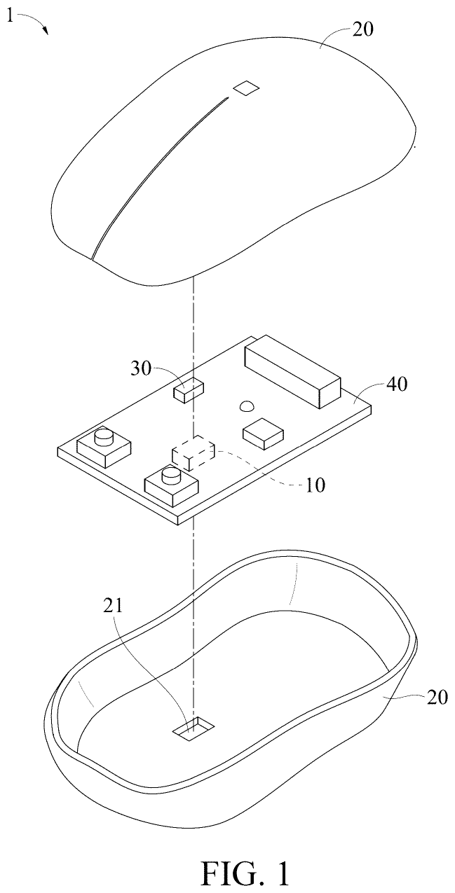

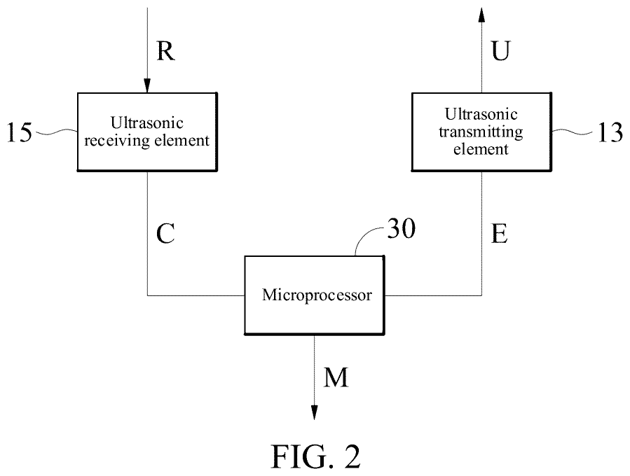

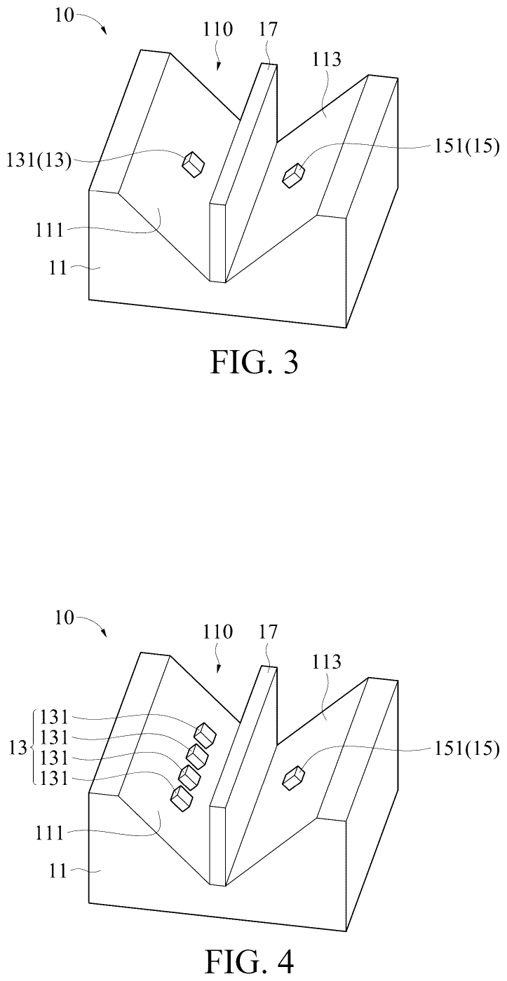

FIG. 1 is an exploded view of an embodiment of an ultrasonic mouse. FIG. 2 is a block diagram of an embodiment of an ultrasonic mouse. FIG. 3 is a three-dimensional view of a first embodiment of an ultrasonic module. As shown in FIG. 1 to FIG. 3, in some embodiments, an ultrasonic mouse 1 includes an ultrasonic module 10, a housing 20, and a microprocessor 30. The ultrasonic module 10 includes a substrate 11, an ultrasonic transmitting element 13, and an ultrasonic receiving element 15. The substrate 11 includes a slot 110. The slot 110 includes a first side 111 and a second side 113. An acute angle is formed between the first side 111 and the second side 113. Herein, the substrate 11 is a semiconductor substrate or a ceramic substrate.

Herein, the ultrasonic module 10 and the microprocessor 30 may be electrically connected to each other through a circuit board 40, and mounted to the housing 20 as an integral module. The housing 20 may be assembled and has an accommodating space to accommodate the ultrasonic module 10, the microprocessor 30, and the circuit board 40. The microprocessor 30 is electrically connected to the ultrasonic transmitting element 13 and the ultrasonic receiving element 15, and generates an actuating signal E to actuate the ultrasonic transmitting element 13 to transmit an ultrasonic wave signal U. The housing 20 includes an opening 21, from which the ultrasonic transmitting element 13 and the ultrasonic receiving element 15 are exposed for sensing.

Referring to FIG. 2 and FIG. 3 again, the ultrasonic transmitting element 13 is arranged on the first side 111, and generates the ultrasonic wave signal U. The ultrasonic receiving element 15 is arranged on the second side 113, and receives a reflected wave R of the ultrasonic wave signal U, for example, a reflected wave R reflected by a desktop. Herein, when the ultrasonic mouse 1 moves, the ultrasonic receiving element 15 generates a receiving signal C based on a reflection angle of the ultrasonic wave signal U, and the microprocessor 30 generates and transmits a displacement signal M based on a change of the receiving signal C.

Referring to FIG. 3 again, as shown in FIG. 3, the ultrasonic module 10 further includes a baffle 17. The baffle 17 is arranged in the slot 110 and located between the ultrasonic transmitting element 13 and the ultrasonic receiving element 15. In this way, the ultrasonic receiving element 15 may be prevented from receiving the ultrasonic wave signal U directly generated by the ultrasonic transmitting element 13, causing interference with the reflected wave R.

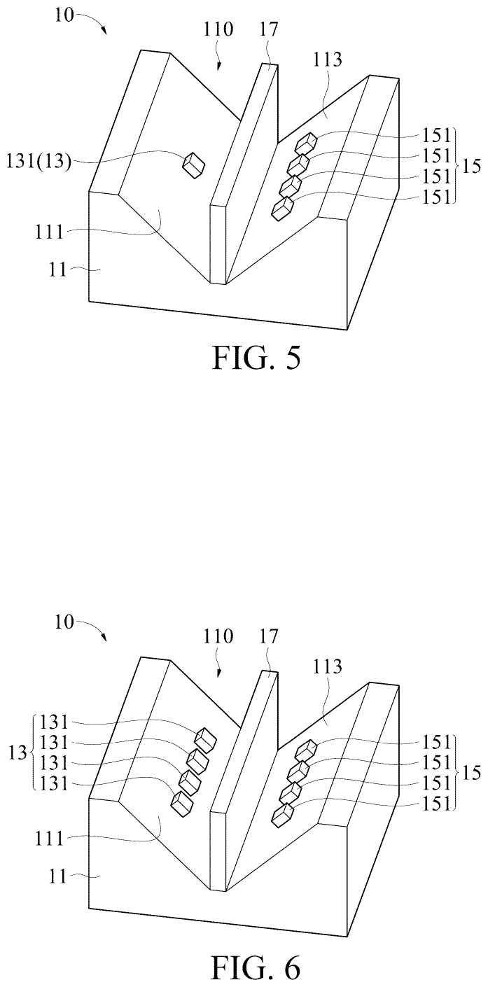

FIG. 4 is a three-dimensional view of a second embodiment of an ultrasonic module. FIG. 5 is a three-dimensional view of a third embodiment of an ultrasonic module. FIG. 6 is a three-dimensional view of a fourth embodiment of an ultrasonic module. As shown in FIG. 4, in an ultrasonic module 10 of the second embodiment, an ultrasonic transmitting element 13 is composed of a plurality of ultrasonic transmitters 131, and an ultrasonic receiving element 15 is a single ultrasonic receiver 151. In other words, many transmitters correspond to one receiver in the second embodiment. As shown in FIG. 5, in the ultrasonic module 10 of the second embodiment, the ultrasonic transmitting element 13 is a single ultrasonic transmitter 131, and the ultrasonic receiving element 15 is composed of a plurality of ultrasonic receivers 151. In other words, one transmitter corresponds to many receivers in the third embodiment. As shown in FIG. 6, in the ultrasonic module 10 in the fourth embodiment, the ultrasonic transmitting element 13 is composed of a plurality of ultrasonic transmitters 131, and the ultrasonic receiving element 15 is also composed of a plurality of ultrasonic receivers 151. In other words, many transmitters correspond to many receivers in the fourth embodiment.

The above are merely examples and not for limitation. An actual quantity and an arrangement mode of the ultrasonic transmitters 131 and the ultrasonic receivers 151 may vary based on actual specifications. The ultrasonic transmitter 131 and the ultrasonic receiver 151 may be implemented by using a piezoelectric micromachined ultrasonic transducer (PMUT). The microprocessor 30 may perform calculation by using a reflection angle of the reflected wave R, or may assist in determination through the ultrasonic receiver 151 that receives the reflected wave R, and calculate and transmit the displacement signal M to a computer to generate a movement of the corresponding mouse.

Based on the above, the ultrasonic module 10 may be applied to the ultrasonic mouse 1, and may be configured to calculate a moving path of the ultrasonic mouse 1 by sensing reflection of ultrasonic waves. In this way, a sensing problem of a traditional optical mouse may be resolved without being affected by a material on which the mouse is placed.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An ultrasonic module, comprising:
a substrate comprising a slot, wherein the slot comprises a first side and a second side, and an acute angle is formed between the first side and the second side;
an ultrasonic transmitting element on the first side and configured to generate an ultrasonic wave signal; and
an ultrasonic receiving element on the second side and configured to receive a reflected wave of the ultrasonic wave signal.

2. The ultrasonic module according to claim 1, further comprising a baffle, wherein the baffle is in the slot and between the ultrasonic transmitting element and the ultrasonic receiving element.

3. The ultrasonic module according to claim 1, wherein the substrate is a semiconductor substrate or a ceramic substrate.

4. The ultrasonic module according to claim 1, wherein the ultrasonic transmitting element comprises one or more ultrasonic transmitters.

5. The ultrasonic module according to claim 4, wherein the ultrasonic receiving element comprises one or more ultrasonic receivers.

6. An ultrasonic mouse, comprising:
an ultrasonic module comprising a substrate, an ultrasonic transmitting element, and an ultrasonic receiving element, wherein the substrate comprises a slot, the slot comprises a first side and a second side, and an acute angle is formed between the first side and the second side, the ultrasonic transmitting element is on the first side and configured to generate an ultrasonic wave signal, and the ultrasonic receiving element is on the second side and configured to receive a reflected wave of the ultrasonic wave signal;
a housing comprising an opening from which the ultrasonic transmitting element and the ultrasonic receiving element are exposed; and
a microprocessor in the housing and electrically connected to the ultrasonic transmitting element and the ultrasonic receiving element, wherein
when the ultrasonic mouse moves, the ultrasonic receiving element generates a receiving signal based on a reflection angle of the ultrasonic wave signal, and the microprocessor generates and transmits a displacement signal based on a change of the receiving signal.

7. The ultrasonic mouse according to claim 6, further comprising a baffle, wherein the baffle is in the slot and between the ultrasonic transmitting element and the ultrasonic receiving element.

8. The ultrasonic mouse according to claim 6, wherein the substrate is a semiconductor substrate or a ceramic substrate.

9. The ultrasonic mouse according to claim 6, wherein the ultrasonic transmitting element comprises one or more ultrasonic transmitters.

10. The ultrasonic mouse according to claim 9, wherein the ultrasonic receiving element comprises one or more ultrasonic receivers.
